(19) United States
(12) Patent Application Publication
(10) Pub. No.: US 2010/0183997 A1
(43) Pub. Date: Jul. 22, 2010

(54) APPARATUS AND METHODS FOR CORRECTION OF ORTHODONTIC MALOCCLUSIONS

(76) Inventor: Ali M. Darendeliler, New South Wales (AU)

Correspondence Address: ABELMAN, FRAYNE & SCHWAB, 666 THIRD AVENUE, 10TH FLOOR, NEW YORK, NY, 10017, US

(21) Appl. No.: 12/450,458

(22) PCT Filed: Mar. 5, 2008
(86) PCT No.: PCT/AU2008/000294

§ 371 Date: Apr. 1, 2010

(30) Foreign Application Priority Data
Mar. 7, 2007 (AU) 2007901315

(51) Int. Cl. A61C 7/08

(52) U.S. Cl. 433/6; 433/24

(57) ABSTRACT

A sequential orthodontic appliance comprising a body (64) for engaging a plurality of teeth, and at least one magnetic (63,68,72) attachment positioned so as to be in attractive or repulsive configuration with a magnet (60,66,70) bonded to a surface of a tooth (60,65,69) in need of repositioning. The body defines a space for allowing movement of the tooth in need of repositioning caused by attraction or repulsion.

### TECHNICAL FIELD

This invention relates to the correction of orthodontic malocclusions and other dental or jaw, jaw joint and related problems, both aesthetic and functional. More particularly, the invention relates to the use of magnets as part of an orthodontic and magnetic force delivery appliance. The invention has particular application in sequential removable appliances and sequential fixed appliances used to correct malpositioned teeth.

### BACKGROUND ART

The problem of malpositioned teeth and the use of removable and fixed appliances to correct that problem has long been a major part of orthodontic treatment. The malpositions of the teeth can be seen in three dimensions. Teeth can be too high, too low, rotated, tipped, incorrectly angulated in different planes, or palatally or lingually malpositioned in relation to their correct or orthodontically ideal positions. Many approaches have been taken to correct the problem of malpositioned teeth.

In the late 19^{th} and early 20^{th} centuries, removable and fixed appliances were introduced for the correction of orthodontic and orthopaedic problems. These appliances were made of many different materials and shapes, and had a variety of mechanisms. Such orthodontic appliances were, and those still in use are, either removable (so that patients can take them out) or fixed (such as with glue) on to the teeth (so that patients cannot take them out, but trained specialists, such as dentists, can take them out) or a combination thereof. Force delivery (or mechanical loading) by the appliance is usually obtained using different types of materials with different elastic properties, such as wires, elastic bands, coils and plastics.

Removable appliances are not as effective as fixed appliances in controlling movement over three dimensions. However, fixed appliances are not considered aesthetically pleasing by most patients and hinder good oral hygiene.

In recent years, new techniques and appliances have been developed using clear thermoplastic materials which are more aesthetically pleasing. These thermoplastic appliances have to be changed regularly and are usually called “sequential removable appliances”. A sequential removable appliance needs to be replaced with a new one usually every second week. These appliances are considered quite effective in achieving tipping movements to correct tipped teeth but not as effective in achieving other types of movements, especially bodily movements, rotations, extrusions and severe intrusions of teeth. Thus, they cannot be used in severe crowding cases and they are not very effective in cases needing extraction of the teeth to create space.

A related disadvantage of known sequential appliances is that they cannot always grasp enough of the anatomy of a tooth or teeth to allow sufficient “purchase” or grip to achieve the desired distance or direction of movement (without slippage or loss of connection of the appliance and tooth or teeth). Furthermore, such appliances cannot control the angulation of a tooth or teeth when they are moving them. Nor can they effectively correct the rotation of a cylindrical tooth, such as a premolar or molar. Attachments can be placed on the teeth to increase the undercuts and the retention and grasp of the appliances, but they are not always very reliable and effective.

Moving teeth vertically is also dependent on the presence of undercuts on the tooth or teeth to provide sufficient “purchase” or grip. However, this is not easily achievable using sequential removable appliances, especially if the discrepancy is severe.

When teeth are extracted for orthodontic reasons, the extraction spaces often need to be closed by moving the neighbouring teeth. If an appliance cannot hold the teeth adequately, the teeth will not move bodily or their angulations cannot be kept steady. Sometimes teeth have to be moved backward or forward without being taken out (distalisation or mesialisation) and these movements also need good control and grasping of the teeth.

The main weaknesses of sequential removable appliances are their three dimensional control and their very short active stage. The amount of movement stored in these appliances is usually around 0.25 to 0.5 mm per tooth or several teeth per appliance every two weeks. This limited movement and the need to change the appliance usually every second week are limiting factors in orthodontic treatment with sequential removable appliances.

### DISCLOSURE OF INVENTION

Accordingly, it is an object of the present invention to provide an improved sequential orthodontic appliance that overcomes the aforementioned problems and shortcomings associated with sequential removable appliances of the prior art.

It is another object of the present invention to provide an improved sequential orthodontic appliance that is aesthetically pleasing and will not lead to poor oral hygiene.

Within the context of this invention, “appliance” means one or more sequentially used, removable or hitherto fixed devices or a combination of such devices used to correct orthodontic and other dental or jaw, jaw joint and related problems or to retain (or preserve) an existing or previously corrected position or relationship of teeth.

Within the context of this invention, “magnetic attachment” means one or more magnets, one or more ferromagnetic materials, a group or special assembly of magnets and/or ferromagnetic materials, and magnetic objects which are coated or uncoated depending on their use.

According to the present invention there is provided a sequential orthodontic appliance comprising a body for engaging a plurality of teeth, and at least one magnetic attachment positioned so as to be in attractive or repulsive configuration with a magnet bonded to a surface of a tooth in need of repositioning, the body defining a space for allowing movement of the tooth in need of repositioning caused by attraction or repulsion.

Preferably, the body is made of a thermoplastic material, although other suitable material may be used.

It is preferred that the sequential orthodontic appliance further includes one or more temporary anchorage devices.

In a preferred form, the body defines a space for the positioning of the at least one magnetic attachment.

In a further preferred form, the at least one magnetic attachment is attached to a surface of the body.

According to another aspect of the present invention there is provided a method for the correction of orthodontic malocclusions comprising:
(a) providing a sequential orthodontic appliance as described above;
(b) fitting the appliance to a plurality of teeth so that the at least one magnetic attachment of the appliance is in attractive or repulsive configuration with a magnet bonded to a surface of a tooth in need of repositioning; and
(c) allowing sufficient time for movement of the tooth in need of repositioning caused by attraction or repulsion.

In an alternative form, the above method may be used in correcting jaw discrepancies or skeletal problems.

A magnetic attachment can also be used to increase the retention of the sequential orthodontic appliance during or following treatment.

### BRIEF DESCRIPTION OF THE DRAWINGS

In order that the invention may be more readily understood and put into practical effect, reference will now be made to the accompanying drawings in which:

FIGS. 1a and 1b are plan views of a plurality of teeth with one tooth in malposition, and sequential orthodontic appliances used to correct the malposition, with magnets bonded onto the malpositioned tooth interacting in attractive or repelling configuration with their antagonist magnets incorporated in the sequential orthodontic appliance,

FIGS. 2a to 2d depict examples of magnetic configurations in extrusion, intrusion and distalisation, with magnets bonded onto a tooth or teeth interacting in attractive or repelling configuration with their antagonist magnets incorporated in the sequential appliance,

FIG. 3 depicts magnetic configurations for rotations, buccal and palatal movements, with magnets bonded onto a tooth or teeth interacting in attractive or repelling configuration with their antagonist magnets incorporated in, or fixed to, the sequential appliance,

FIGS. 4a and 4b depict examples of magnetic configurations in extraction and distalisation cases, with magnets bonded onto a tooth or teeth interacting in attractive or repelling configuration with their antagonist magnets incorporated in the sequential appliance,

FIG. 4c depicts examples of magnetic configuration in extraction and distalisation cases, with magnets bonded onto a tooth or teeth interacting in attractive or repelling configuration with their antagonist magnets also bonded onto a tooth or teeth,

FIG. 4d depicts other examples of magnetic configuration in extraction and distalisation cases, with magnets bonded onto both a tooth or teeth and the sequential appliance,

FIGS. 5a to 5c show a first positional relationship of magnets incorporated in sequential appliances for the correction of upper and lower dentition and/or jaw discrepancies,

FIG. 6 shows a second positional relationship of magnets incorporated in sequential appliances for the correction of upper and lower dentition and/or jaw discrepancies, and showing an upper aligner appliance and a lower aligner appliance with a single magnet in each aligner appliance,

FIG. 7 shows a three-magnet configuration with two magnets in the upper aligner appliance and one magnet in the lower aligner appliance,

FIG. 8 shows a four-magnet configuration with two magnets in the upper aligner appliance and two magnets in the lower aligner appliance,

FIG. 9 shows another positional relationship of magnets incorporated in sequential appliances for the correction of upper and lower dentition and/or jaw discrepancies, and showing an upper aligner appliance and a lower aligner appliance with a single magnet in each aligner appliance,

FIG. 10 shows the use of temporary anchorage devices with a sequential appliance to secure the appliance to the bone,

FIG. 11 shows a temporary anchorage device magnetically attached to a sequential appliance,

FIG. 12 depicts an example of adjustable magnetic configuration in extraction and distalisation cases,

FIG. 13 shows a first adjustable device used in the arrangement of FIG. 12,

FIG. 14 shows a second adjustable device used in the arrangement of FIG. 12, and

FIG. 15 shows an adjustable positional relationship of magnets fitted to a sequential appliance engaged to a single jaw for the correction of upper and lower dentition and/or jaw discrepancies.

### MODES FOR CARRYING OUT THE INVENTION

Using magnetic attachments on the teeth and/or included in the sequential orthodontic appliances will create a magnetic force interaction and make the movement of teeth in any direction possible and easier. The dimensions, structure, number and composition of the magnetic attachments and their coating type or material will depend on space available, force level and type of movement needed.

In the case of rotation, one or more magnetic attachments will be fixed on the tooth and one or more antagonist magnetic attachments will be fixed to the body of, or incorporated in, the appliance in attractive and/or in repulsive (i.e. repelling) configuration.

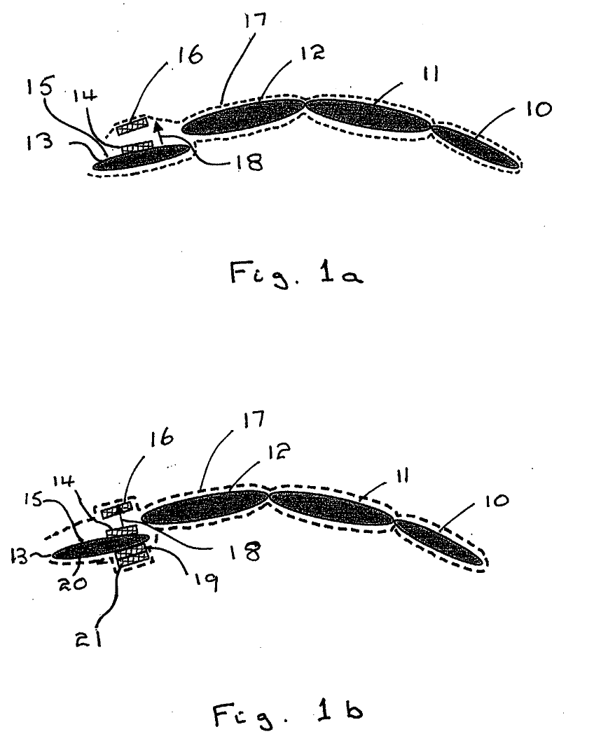

FIG. 1a shows upper incisor teeth 10, 11, 12 and 13, with tooth 13 being in malposition. A first magnet 14 is bonded to the vestibular surface 15 of tooth 13 and a second magnet 16 is incorporated in a sequential orthodontic appliance 17, the body of which is shown in dotted outline and engages the teeth 10 to 13. Magnets 14 and 16 attract one another as indicated by arrow 18, drawing the tooth 13 forwardly towards its correct position.

FIG. 1b is similar to FIG. 1a but with the addition of a third magnet 19 bonded to the palatal surface 20 of the tooth 13, and a fourth magnet 21 incorporated in a sequential orthodontic appliance 22, the body of which is shown in dotted outline. Magnets 19 and 21 repel one another, whilst the magnets 14 and 16 attract one another, the assembly of magnets interacting in a repelling and attractive configuration, the result of which is to draw the tooth 13 forwardly towards its correct position.

In the case of extrusion or intrusion (in the buccal, palatal or lingual position) of one or several teeth, the position of the magnetic attachments will dictate the direction of the vertical movement of the tooth or teeth.

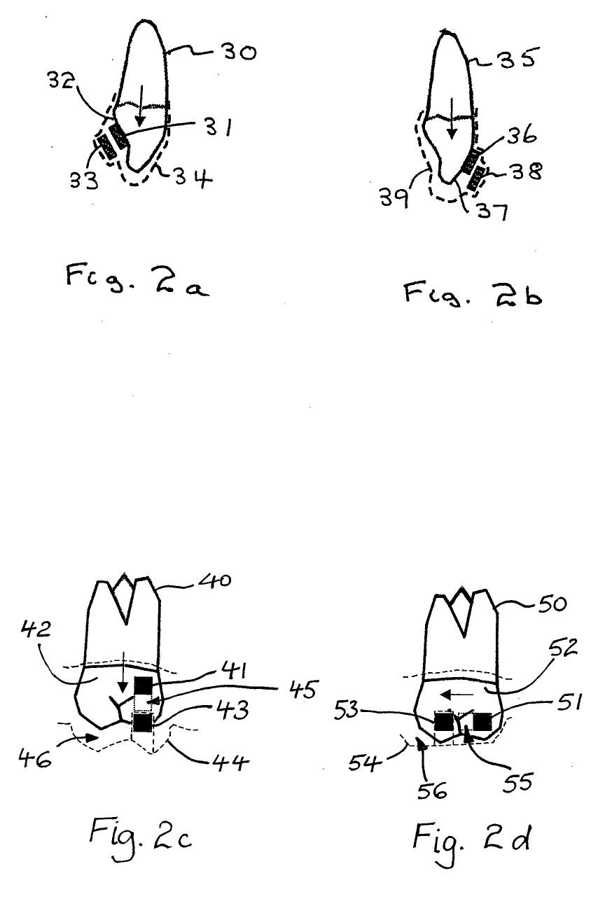

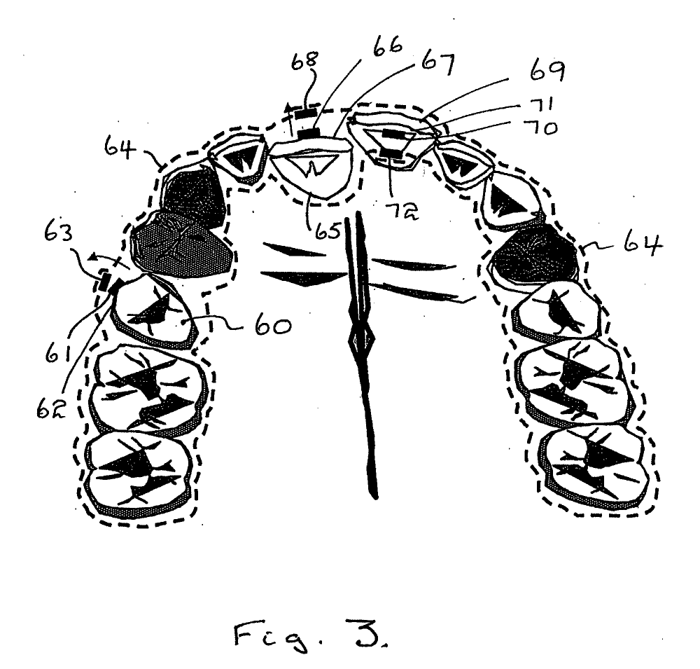

Examples of magnetic configuration in extrusion, intrusion and distalisation are shown in FIGS. 2a to 2d.

In FIG. 2a, tooth 30 has a magnet 31 bonded to its palatal surface 32 and an attractive magnet 33 is incorporated in the sequential appliance 34.

In FIG. 2b, tooth 35 has a magnet 36 bonded to its buccal surface 37 and a repulsive magnet 38, in attractive configuration with the magnet 36, is incorporated in the sequential appliance 39.

In FIG. 2c, the tooth 40 has a magnet 41 bonded to its buccal surface 42 and a magnet 43, in attractive configuration with the magnet 41, is fixed to the body 44 of a sequential appliance. The body of the sequential appliance has a space 45 or vertical passageway between the magnets 41, 43 and a space 46 beneath the tooth 40 for allowing vertical movement of the tooth 40 caused by attraction of the magnets 41, 43.

In FIG. 2d, the tooth 50 has a magnet 51 bonded to its buccal surface 52 and a magnet 53, in attractive configuration with the magnet 51, is fixed to the body 54 of a sequential appliance. The body of the sequential appliance has a space 55 or horizontal passageway between the magnets 51, 53 and a space 56 forward of the tooth 50 for allowing horizontal movement of the tooth 50 caused by attraction of the magnets 51, 53.

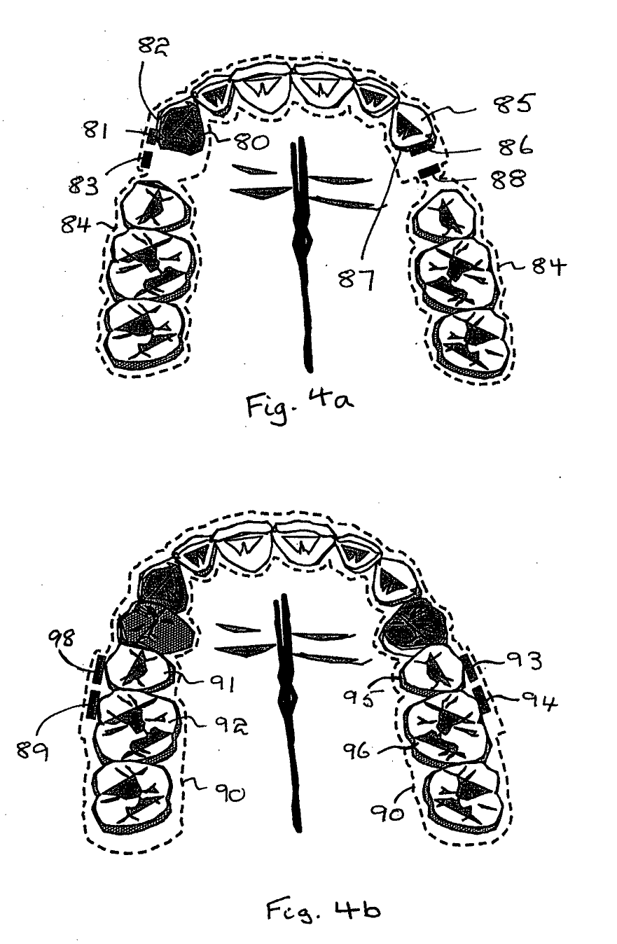

The tooth 60 shown in FIG. 3 has a magnet 61 bonded to its vestibular surface 62 and a magnet 63, in attractive configuration with the magnet 61, is incorporated in the sequential appliance 64 for the correction of the rotation of the tooth 60. Tooth 65 has a magnet 66 bonded to its vestibular surface 67 and an attractive magnet 68 is incorporated in the sequential appliance 64 to pull it buccally. Tooth 69 has a magnet 70 bonded to its palatal surface 71 and an attractive magnet 72 is incorporated in the sequential appliance 64. The body of the sequential appliance 64, shown in dotted outline, surrounds and thereby engages all of the teeth, but defines some spaces for allowing movement of teeth 60, 65 and 69. The overall effect of the magnetic configuration of FIG. 3 is that teeth 60 and 65 are drawn outwardly, tooth 60 is also rotated to the correct angulation and tooth 69 is drawn inwardly.

In the case of distalisation and mesialisation of one or several teeth, the position of the magnetic attachments will dictate the direction of the horizontal movement of the tooth or teeth. This can be used in extraction or non-extraction treatments.

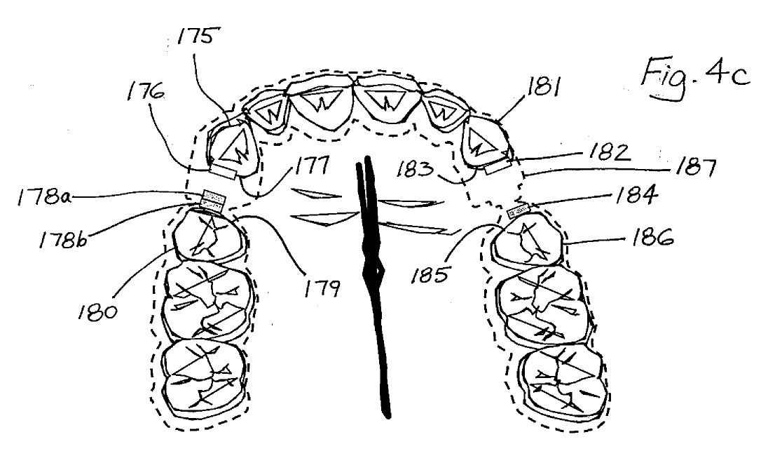

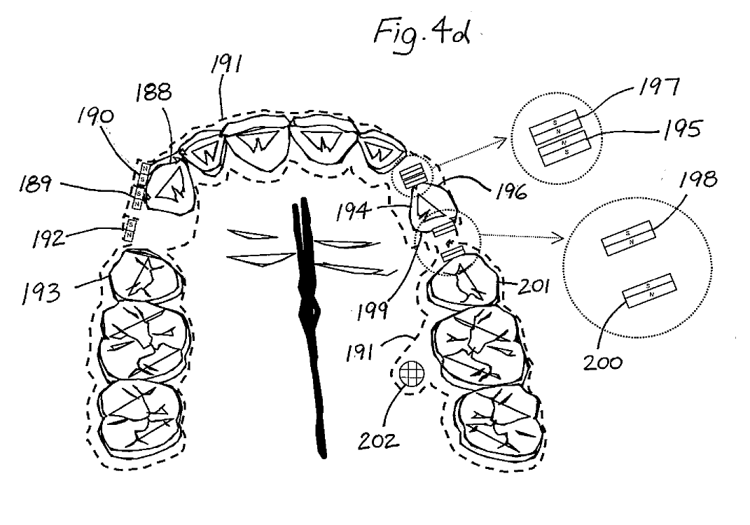

FIGS. 4a and 4b show examples of magnetic configuration in cases of extraction and distalisation. In FIG. 4a, tooth 80 has a magnet 81 bonded to its vestibular surface 82 and an attractive magnet 83 is incorporated in the sequential appliance 84. Tooth 85 has a magnet 86 bonded to its surface 87 and an attractive magnet 88 is incorporated in the sequential appliance 84. When the teeth 80 or 85 are closer to the premolars, the magnets 83 and 88 can alternatively be bonded on the premolars.

In FIG. 4b, the magnets 98 and 89 are in repulsive configuration, and the magnets 93 and 94 are in repulsive configuration. The magnets 98 and 89 are bonded on the vestibular surfaces of the teeth 91 and 92, respectively, and the magnets 93 and 94 are bonded on the vestibular surfaces of the teeth 95 and 96, respectively, to move the adjacent molars distally. In an alternative embodiment, the magnets 98 and 93 are incorporated in the sequential appliance 90.

FIG. 4c shows further examples of magnetic configuration in cases of extraction and distalisation. The tooth 175 has a magnet 176 bonded to its surface 177 and a magnetically connected pair of magnets 178a, 178b, in attractive configuration with the magnet 176, is bonded to the surface 179 of tooth 180. When the tooth 175 moves closer to the premolar 180, the magnet 178a can be removed from its position as shown to allow further room for movement of the tooth 175 and its bonded magnet 176 towards the remaining magnet 178b on tooth 180. Alternatively, the pair of magnets, 178a, 178b, is incorporated in the sequential appliance 187, and when the tooth 175 moves closer to the premolar 180, the magnet 178a can be removed from its position as shown to allow further room for movement as described above. Tooth 181 has a magnet 182 bonded to its surface 183 and a magnet 184, in attractive configuration with the magnet 182, is bonded to the surface 185 of tooth 186. The sequential appliance 187 has a body so configured as to allow sufficient space for the desired movement of the teeth, particularly the canines 175 and 181, under the influence of the attracting magnetic forces.

FIG. 4d shows still further examples of magnetic configuration in cases of extraction and distalisation. The tooth 188 has a magnet 189 bonded to its buccal surface rearwardly of, and alongside, a repulsive magnet 190 incorporated in the sequential appliance 191, but forwardly of, and spaced apart from, an attractive magnet 192 also incorporated in the sequential appliance 191. Thus, there is a repulsive force between magnets 189 and 190 and an attractive force between magnets 189 and 192 that will move the canine tooth 188 towards the premolar tooth 193 under a constant force during its movement through the space between these teeth that is available by the configuration of the body of the appliance 191.

Also shown in FIG. 4d, the tooth 194 has a magnet 195 bonded to its surface 196 rearwardly of, and alongside, a repulsive magnet 197 incorporated in the sequential appliance 191. The tooth 194 also has a magnet 198 bonded to its opposite surface 199 which is forwardly of, and spaced apart from, an attractive magnet 200 bonded to the tooth 201.

In an alternative embodiment, the magnet 200 is incorporated in the sequential appliance 191. Thus, there is a repulsive force between the magnets 195 and 197 and an attractive force between the magnets 198 and 200 that will move the canine tooth 194 towards the premolar tooth 201 under a constant force throughout its displacement.

There is also shown in FIG. 4d a temporary anchorage device 202 for securing the appliance 191 on the bone, when required. The body of the appliance 191 includes a mounting portion which is used to connect the device 202 thereto.

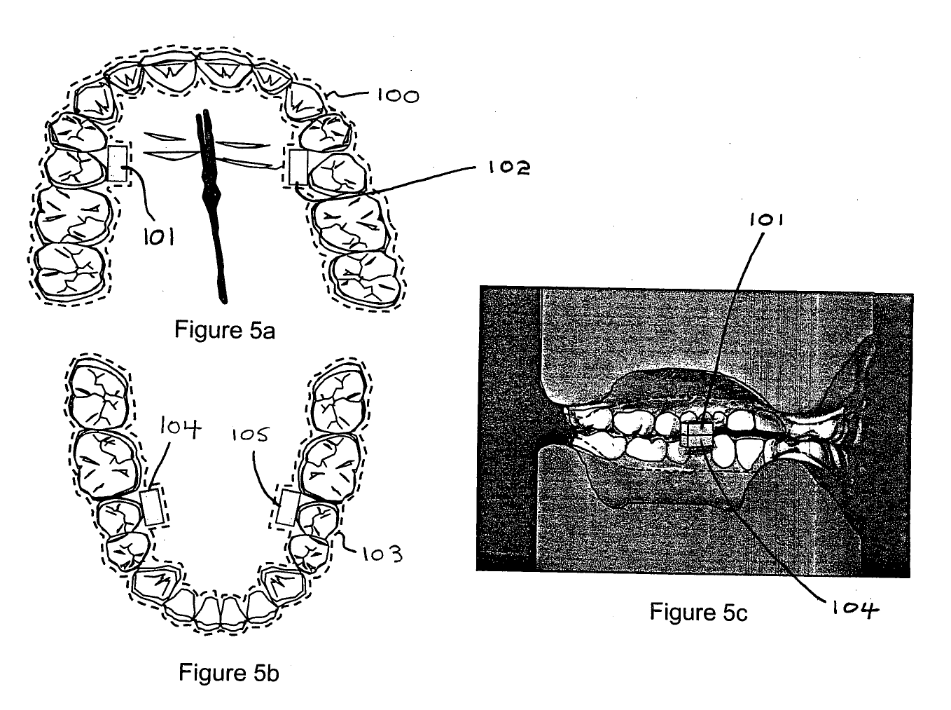

A preferred magnetic configuration to correct upper and lower dentition and/or jaw discrepancies is shown in FIGS. 5a to 5c. Upper sequential appliance 100 incorporates magnets 101 and 102 (see FIG. 5a) and lower sequential appliance 103 incorporates attractive magnets 104 and 105 (see FIG. 5b). The vertical alignment of magnets 101 and 104 is shown in FIG. 5c.

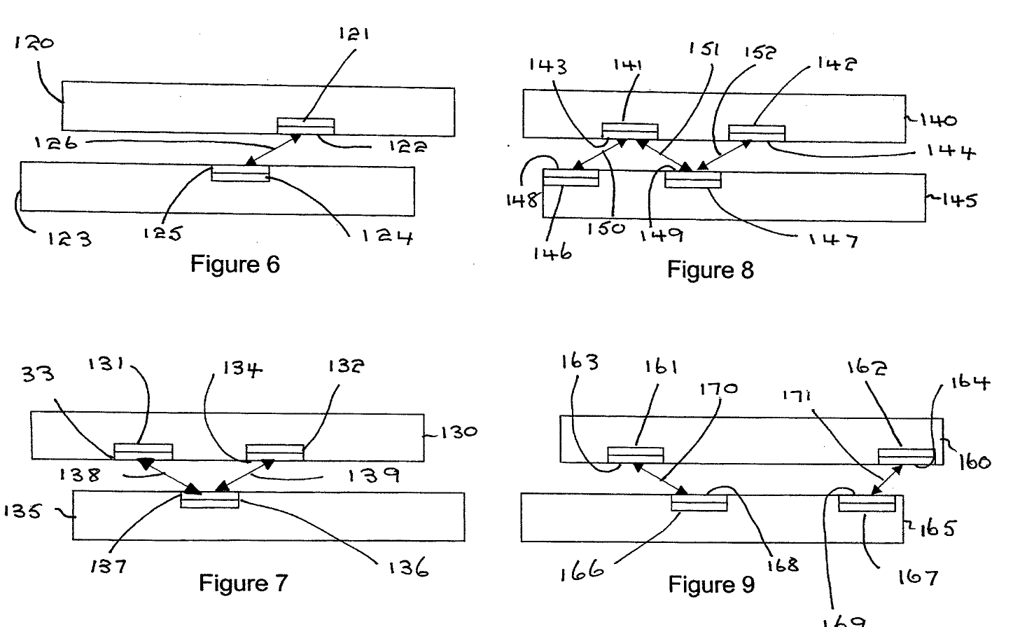

FIGS. 6 to 9 show schematically various magnet configurations for correction of upper and lower dentition and/or jaw discrepancies. The upper and lower sequential appliances will be referred to in relation to FIGS. 6 to 9 as upper and lower aligners, respectively.

In FIG. 6, the upper aligner 120 has a single magnet 121 with its south pole 122 exposed and the lower aligner 123 has a single magnet 124 with its north pole 125 exposed so that there is an attractive magnetic force vector 126 therebetween.

In FIG. 7, the upper aligner 130 has two spaced apart magnets 131 and 132 with the north pole 133 of the magnet 131 and the south pole 134 of the magnet 132 exposed. The lower aligner 135 has a single magnet 136 with its north pole 137 exposed. The magnet 136 is located between the upper magnets 131 and 132 so that there is a repulsive magnetic force vector 138 between the magnets 131 and 136 and an attractive magnetic force vector 139 between magnets 132 and 136.

In FIG. 8, the upper aligner 140 has two spaced apart magnets 141 and 142 with the north pole 143 of the magnet 141 and the south pole 144 of the magnet 142 exposed. The lower aligner 145 has two spaced apart magnets 146 and 147 with the south pole 148 of the magnet 146 and the north pole 149 of the magnet 147 exposed. The magnets 146, 141, 147 and 142 are offset in relation to one another so that there is an attractive force vector 150 between magnets 141 and 146 and a repulsive magnetic force vector 151 between magnets 141 and 147 and an attractive magnetic force vector 152 between magnets 142 and 147.

In FIG. 9, the upper aligner 160 has a pair of spaced apart magnets 161 and 162 with the north pole 163 of the magnet 161 and the south pole 164 of the magnet 162 exposed. The lower aligner 165 has a pair of spaced apart magnets 166 and 167 with the north poles 168 and 169 being exposed. As can be seen in FIG. 9, the magnets 162 and 167 partially overlap and the spacing between magnets 161 and 162 is larger than the spacing between the magnets 166 and 167 so that the magnets 161 and 166 do not overlap. There is a repulsive magnetic force vector 170 between magnets 161 and 166 and an attractive magnetic force vector 171 between magnets 162 and 167.

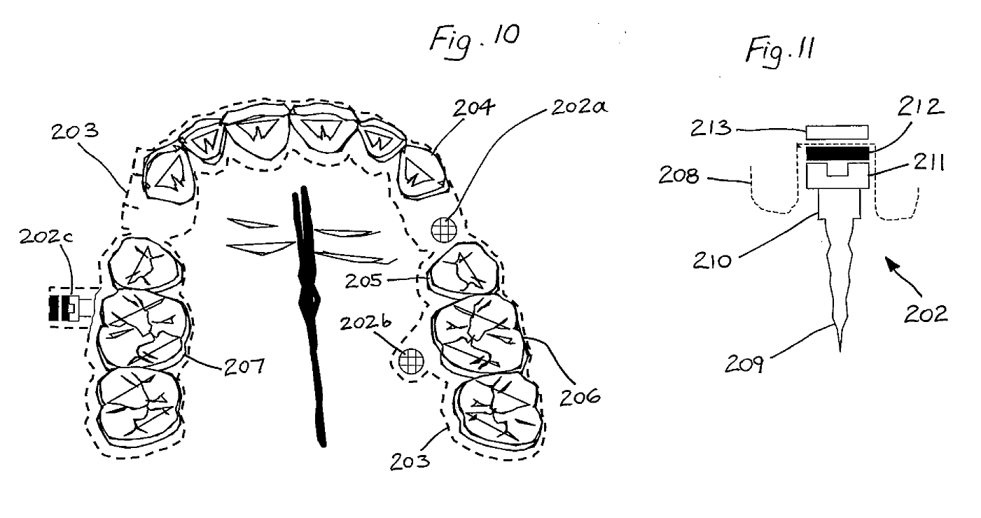

FIG. 10 shows a sequential appliance 203 secured to a jaw bone by a plurality of the temporary anchorage devices 202.

A first device 202a, which is connected to the appliance 203 via a mounting portion of the body, is shown vertically securing the appliance 203 to the bone between a canine tooth 204 and premolar tooth 205, a second connected device 202b is shown vertically securing the appliance 203 to the bone interiorly of the molar tooth 206, and a third device 202c, which is included in the appliance 203, is shown horizontally securing the body of the appliance 203 to the bone beneath the molar tooth 207.

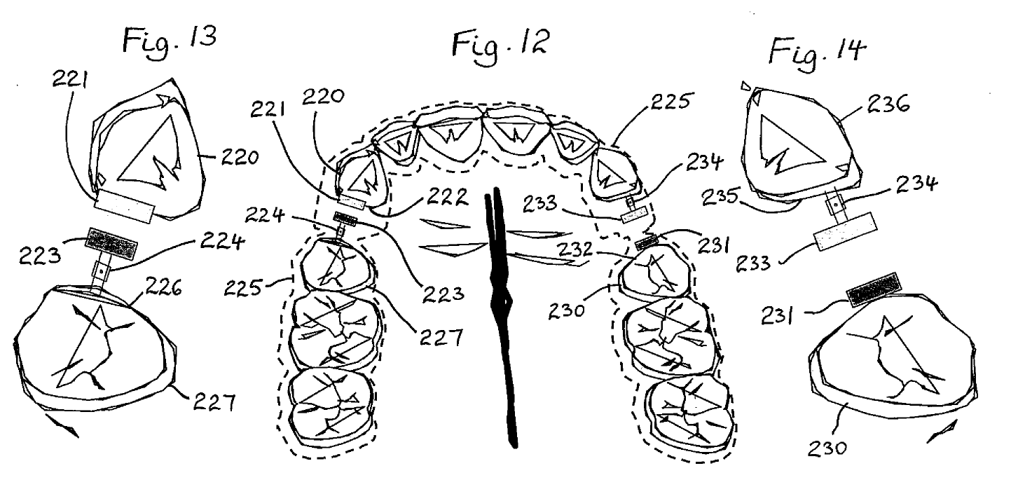

The temporary anchorage device 202 shown in FIG. 11 is magnetically connected to the body of the sequential appliance 208. The device 202 includes a tapered and threaded shaft 209 for securing the device to a bone or other structure, a polished transmucosal collar 210, a head 211, and a magnetic cap 212 which is in attractive configuration with a magnet 213 secured to the body of the sequential appliance 208. In an alternative embodiment, the magnets 212 and 213 are replaced by any suitable ferromagnetic material.

It will also be appreciated that the sequential appliance may be secured to the bone or other structure by normal orthodontic screws or bolts, or by other equivalent mechanical or magnetic securing devices.

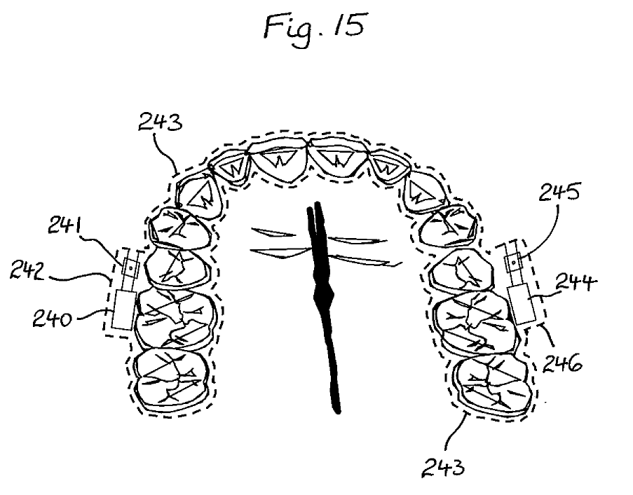

FIG. 12 shows an example of adjustable magnetic configuration in cases of extraction and distalisation. The canine tooth 220 has a magnet 221 bonded to its surface 222 and an attractive magnet 223 is secured to a device 224 that can be operated so as to adjust the position of the magnet 223 relative to the magnet 221. The device 224 is preferably secured to the sequential appliance 225, but may alternatively be bonded to the surface 226 of premolar tooth 227 (as shown in FIG. 13).

The premolar tooth 230 has a magnet 231 bonded to its surface 232 and an attractive magnet 233 is secured to a device 234 similar to device 224. The device 234 is preferably secured to the sequential appliance 225, but may alternatively be bonded to the surface 235 of canine tooth 236 (as shown in FIG. 14).

The sequential appliance 225 has a body so configured as to allow sufficient space for the desired movement of the canine teeth under the influence of the attracting magnetic forces. Positional adjustment of the magnets 223, 233 relative to magnets 221, 231, respectively, by operation of the device 224, 234 allows the attractive force level to be regulated to suit the desired effect.

FIG. 15 shows an example of adjustable magnetic configuration for a single jaw to correct upper and lower dentition and/or upper and lower jaw discrepancies. A magnet 240 is secured to an adjustable device 241 which, in turn, is secured to an outer body portion 242 of the sequential appliance 243 at a first side of the jaw. A magnet 244 is secured to an adjustable device 245 which is also secured to an opposed, outer body portion 246 of the sequential appliance 243 at a second, or opposite, side of the jaw. The devices 241,245 allow the position of the magnets 240, 244 to be adjusted forwardly or rearwardly and relative to the position of corresponding magnets (not shown) that are positioned with respect to the other jaw in such a way as to facilitate vertical alignment of the upper and lower jaws at a regulated level of attractive force. The corresponding magnets are preferably secured to adjustable devices fitted to a sequential appliance, although they may alternatively be secured to adjustable or non-adjustable devices bonded directly to the surface of the teeth. The arrangement allows for changing the direction of the attractive or repulsive forces between each sequential appliance that is used over the period of treatment, as well as between the sequential appliances on the upper and lower jaws.

In the case of impacted or unerupted teeth, magnetic attachments can also be used in conjunction with sequential appliances. Following the exposure of the impacted tooth by opening the overlaying gum, a magnetic attachment can be fixed on the impacted tooth and the gum flap can be closed. Using another magnetic attachment on the sequential appliance, an attracting magnetic force can be created between them and the impacted/unerupted tooth or teeth will erupt if there is no other pathology.

Magnetic attachments may be available in an assembly or kit to make the delivery, fixing and use of them more practical, hygienic and safer.

Sometimes the upper and lower dentitions do not match and there is a need for correction of that problem simultaneously with, or during some stage(s) of, the treatment with sequential appliances. In the case of conventional fixed appliances, elastic bands are used between the upper and lower appliances and the treatment success depends on the length and tension of these elastic bands.

When removable appliances are used, the elastic bands can only be worn on fixed attachments on the teeth. This will require important patient cooperation and also jeopardize the aim of using an aesthetically pleasing sequential appliance without having anything fixed on the teeth. Sometimes elastic bands are worn between the hooks, buttons, and undercuts created on the appliances. The use of elastic bands in this way may decrease the retention of the appliances as they are not fixed on the teeth or other structures.

Magnets can be incorporated in the sequential orthodontic appliances in such a way that upper and lower dentitions will be pulled and/or pushed in the direction of correction, and so may act in a similar manner to intermaxillary elastic bands. This means that, as soon as the sequential appliances are worn, the intermaxillary magnetic force vectors will be in action.

Another advantage of using the magnets as part of the sequential orthodontic appliances is that, in growing patients, the magnetic forces will hold the lower jaw in a correct position in three dimensions and a positional adaptation by growth modification will occur. The jaw correction otherwise has to be done before the use of fixed or removable appliances and extends the duration of treatment. Another advantage is that the magnets direct a patient's jaws into a correct position when they are asleep, and this creates greater efficacy in their action. This in turn may reduce the duration over which the appliance is required to be fitted to the teeth, and further increases its acceptability to patients. It also allows a more physiological and functional adaptation to an ideal jaw position.

Magnetic attachments may also be used in the correction of dental and/or skeletal vertical discrepancies, such as open-bite and deep-bite. In that case, magnetic attachments can be used in repulsive or attractive configuration or in combination to facilitate and correct these vertical discrepancies.

Magnetic attachments can also be used in the correction of transverse problems, such as midline shift due to dental shift or due to jaw shift (functional or morphological).

The magnetic attachments may be located before or after the impressions and/or scanning of the dental/oral structures and may be fixed directly to the teeth and I or to the appliances. The magnetic attachments may need to be fixed during each appointment by the dentist or by dental auxiliary staff, or by the patient when required. The magnetic attachments may also be incorporated in the appliances during the production stage, or as part of a marketing process. The magnetic attachments may be positioned on the buccal, occlusal, palatal or lingual sides of the teeth or at a combination of different sides of the teeth. The magnetic attachments may be interchangeable or transferable between each sequential appliance used by the patient. This transfer may be done by the clinician, dental therapist, hygienist or dental auxiliary staff, or by the patient when necessary.

Magnetic attachments on the teeth or incorporated in the appliances can be used in different arrangements and configurations. These configurations may consist of two, three, four or more magnetic attachments in attraction and/or in repulsion as required.

The magnets may be of any dimension and shape and may be used in conjunction with other ferromagnetic materials. They can be coated or sealed with any suitable material.

The magnets can also be used in conjunction with temporary anchorage devices, such as implants, pins, plates and/or screws. The magnets may interact with anchorage devices or may be incorporated in the anchorage devices.

Magnetic attachments can be used to increase the retention of the appliances during their use in dental applications particularly when obtaining certain tooth movements at the same time.

1. A sequential orthodontic appliance comprising a body for engaging a plurality of teeth, and at least one magnetic attachment positioned so as to be in attractive or repulsive configuration with a magnet bonded to a surface of a tooth or teeth in need of repositioning, the body defining a space for allowing movement of the tooth or teeth in need of repositioning caused by attraction or repulsion.

2. The sequential orthodontic appliance of claim 1 wherein the body is made of a thermoplastic material.

3. The sequential orthodontic appliance of claim 1 and further including one or more temporary anchorage devices.

4. The sequential orthodontic appliance of claim 1 and further including means for connecting to one or more temporary anchorage devices.

5. The sequential orthodontic appliance of claim 1 wherein the body defines a space for the positioning of the at least one magnetic attachment.

6. The sequential orthodontic appliance of claim 1 wherein a first magnetic attachment is positioned so as to be in attractive configuration with a magnet bonded to an outermost surface of an unerupted tooth in need of eruption through the gum overlaying the tooth.

7. The sequential orthodontic appliance of claim 1 wherein the at least one magnetic attachment comprises a magnetically connected pair of magnets positioned so as to be in attractive configuration with a magnet bonded to a surface of a tooth in need of repositioning, the magnet of the pair closest to the tooth in need of repositioning being removable to allow further room for movement of the tooth.

8. The sequential orthodontic appliance of claim 1 and further including means for adjusting the position of the at least one magnetic attachment.

9. A sequential orthodontic appliance comprising a body for engaging a plurality of teeth, and at least one magnetic attachment positioned so as to be in attractive configuration with a magnet bonded to a surface of a tooth or teeth for the purpose of retention of the sequential orthodontic appliance in its engaged position.

10. A method for the correction of orthodontic malocclusions comprising:
(a) providing the sequential orthodontic appliance of claim 1;
(b) fitting the appliance to a plurality of teeth so that the at least one magnetic attachment of the appliance is in attractive or repulsive configuration with a magnet bonded to a surface of a tooth or teeth in need of repositioning; and
(c) allowing sufficient time for movement of the tooth or teeth in need of repositioning caused by attraction or repulsion.
